(19) United States
(12) Patent Application Publication
(10) Pub. No.: US 2001/0015171 A1
(43) Pub. Date: Aug. 23, 2001

(54) Treatment apparatus

(76) Inventor: Kazuhiko Ooshima, Kikuchi-gun (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/788,557

(22) Filed: Feb. 21, 2001

(30) Foreign Application Priority Data
Feb. 22, 2000 (JP) 2000-044361

(51) Int. Cl. B05C 11/00

(52) U.S. Cl. 118/58

(57) ABSTRACT

The present invention is treatment apparatus for performing predetermined treatment by exposing substrate to gaseous atmosphere, and comprises a chamber for receiving substrate, liquid line for supplying liquid for forming the gaseous atmosphere, liquid flow control device for controlling an amount of liquid flow of liquid line, vaporizer for vaporizing liquid supplied from the liquid line, carrier gas line for supplying carrier gas for carrying gas vaporized in vaporizer, and gas supply line for supplying gas vaporized in vaporizer into chamber while being carried by carrier gas. Since liquid is vaporized by vaporizer while controlling amount of liquid flow of liquid line, it is possible to perform vaporization in a certain amount from certain amount of the liquid and to surely and controllably form gaseous atmosphere with stable concentration, without being influenced by environment.

### CROSS-REFERENCE TO RELATED APPLICATIONS

This application is based upon and claims the benefit of priority from the prior Japanese Patent Application No. 2000-044361, filed Feb. 22, 2000, the entire contents of which are incorporated herein by reference.

### BACKGROUND OF THE INVENTION

1. Field of the Invention

This invention relates to a treatment apparatus.

2. Description of the Related Art

In a process of photolithography in a fabricating process of a semiconductor device, a resist is coated onto a semiconductor wafer (hereinafter simply referred to as wafer), a resist film formed thereby is exposed according to a predetermined circuit pattern, and thus-exposed pattern is subjected to a developing so that the predetermined circuit pattern is formed on the resist film.

A resist coating and developing treatment system has been hitherto used in order to perform a series of process like this. This kind of resist coating and developing treatment system is structured by integrally providing a process station in which various process units for operating various treatments for coating and developing the wafer are disposed in multiple tiers, a cassette station in which a cassette for receiving a plurality of the wafers is mounted, for carrying the wafer into the process station one by one and carrying out the wafer after the treatment from the process station to be received into the cassette, and an interface section for delivering the semiconductor wafer from/to an exposure unit which is provided next to the system for exposing the resist film according to a predetermined pattern.

In the resist coating and developing treatment system like this, the wafer W is removed one by one from the cassette which is mounted on the cassette station to be transferred to the process station, subjected to a hydrophobic treatment in an adhesion treatment unit, cooled in a cooling unit, coated with a photo resist film in a resist coating unit, and subjected to a prebaking processing in a hot plate unit (heating processing unit).

Thereafter, the wafer is transferred from the process station through the interface section to the exposure unit to be exposed according to a predetermined pattern on the resist film in the exposure unit. After the exposure, the wafer is transferred through the interface section to the process station again, and the exposed wafer is first subjected to a post-exposure baking processing in the hot plate unit, cooled, and then a developing solution is coated thereon in a developing treatment unit for developing the exposed pattern. Subsequently, it undergoes a post baking processing in the hot plate unit and cooled, thereby completing a series of treatments. After the series of treatments, the wafer is transferred to the cassette station to be received in the wafer cassette.

Among the above series of treatments, the adhesion treatment is a treatment for changing a surface of the wafer from hydrophilic to hydrophobic by supplying an HMDS (hexamethyldisilazane) vapor to the wafer which is disposed horizontally in a chamber, and in concrete, OH group bonds of a base substrate of an oxide film are chemically separated to remove moisture.

Conventionally, in this treatment, HMDS in a liquid state in a sealed tank is vaporized naturally, and this atmosphere is force-fed by, for example, an N₂ gas to be supplied into the chamber in which the semiconductor wafer is received. A liquid level (liquid capacity) inside the tank is monitored by a liquid level detecting sensor, and the liquid is supplied thereto when the liquid level is lowered in order to keep a constant liquid level at all times so that a the surface area of the liquid and an atmosphere capacity inside the tank can be kept constant, which makes it possible to obtain the gaseous atmosphere of relatively stable concentration.

However, in the method like this, since HMDS in the liquid state is vaporized naturally and this atmosphere is used, it is significantly influenced by an ambient temperature. Therefore, if the ambient temperature changes, a state of vaporization also changes, resulting in variations in the atmosphere concentration. That is, there is a problem of bad reproducibility and controllability of the atmosphere concentration. Further, there is also a problem of lack of stability because the difference between the respective apparatus easily occurs.

### BRIEF SUMMARY OF THE INVENTION

The present invention is made in view of the above circumstances, and its object is to provide a treatment apparatus which is able to controllably form a gaseous atmosphere with stable concentration without being influenced by environment.

According to a first aspect of the present invention, the present invention is a treatment apparatus for performing a predetermined treatment by exposing a substrate to the gaseous atmosphere, and comprises a chamber for receiving the substrate, a liquid line for supplying a liquid for forming the gaseous atmosphere, a liquid flow control device for controlling an amount of a liquid flow of the liquid line, a vaporizer for vaporizing the liquid supplied from the liquid line, a carrier gas line for supplying a carrier gas for carrying a gas vaporized in the vaporizer, and a gas supply line for supplying the gas vaporized in the vaporizer into the chamber while being carried by the carrier gas.

In this case, it is preferable to further comprise a carrier gas flow control device provided on the carrier gas line for controlling a flow amount of the carrier gas.

According to a second aspect of the present invention, the present invention is a treatment apparatus for performing a predetermined process by exposing the substrate to the gaseous atmosphere, and comprises a chamber for receiving the substrate, a liquid line for supplying a liquid for forming the gaseous atmosphere, a first flow control device provided on the liquid line, a vaporizer for vaporizing the liquid supplied from the liquid line, a carrier gas line for supplying a carrier gas for carrying a gas vaporized in the vaporizer, a second flow control device provided on the carrier gas line, and a gas supply line for supplying the gas vaporized in the vaporizer into the chamber while being carried by the carrier gas.

According to the present invention, the liquid is vaporized by the vaporizer while controlling the amount of the liquid flow of the liquid line, which makes it possible to perform vaporization in a certain amount from a certain amount of the liquid and to surely and controllably form the gaseous atmosphere with stable concentration, without being influenced by environment. Particularly, a flow control device, for example, a mass flow controller is provided on the liquid line and the carrier gas line so that the amount of the vaporizing liquid and the supplying amount of the vaporized liquid can be easily controlled, thereby allowing the concentration of the atmosphere to be controlled quite easily.

By providing a control device for controlling the liquid line to be opened after the carrier gas line is opened when the supplying of the gas is started, and the carrier gas line to be closed after the liquid line is closed when the supplying of the gas is finished, the supplying of liquid only to the vaporizer can be inhibited and the flowing-in of the liquid as it is without being vaporized to a piping after the vaporizer can be prevented.

Further, when the first and the second flow control devices respectively comprise the mass flow controller, in concrete, the mass flow controller of the first flow control device of the liquid line is controlled to be opened after the mass flow controller of the second flow control device of the carrier gas line is opened when the supplying of the gas is started, and the mass flow controller of the second flow control device is controlled to be closed after the mass flow controller of the first flow control device is closed when the supplying of the gas is finished, whereby the supplying of liquid only to the vaporizer can be inhibited and the flowing-in of the liquid as it is without being vaporized to the piping after the vaporizer can be prevented.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a plane view showing an outline of an entire structure of the resist coating and developing treatment system which includes the adhesion unit according to an embodiment of the present invention;

FIG. 2 is a front view showing the entire structure of the resist coating and developing treatment system in FIG. 1;

FIG. 3 is a rear view showing the entire structure of the resist coating and developing treatment system in FIG. 1;

FIG. 4 is an explanatory view showing an outline of a structure of an adhesion unit according to the embodiment of the present invention;

FIG. 5 is an explanatory view showing an outline of a structure of an adhesion unit according to another embodiment of the present invention;

FIG. 6 is an explanatory view showing an outline of a structure of a vaporizer including heater modules, and

FIG. 7 is an explanatory view showing an outline of a structure of a vaporizer of an ultrasonic type.

### DETAILED DESCRIPTION OF THE INVENTION

Hereinafter, the preferred embodiments of the present invention will be explained in detail with reference to the attached drawings.

First, the entire structure of a resist coating and developing treatment system on which an adhesion unit according to an embodiment of the present invention is mounted will be explained.

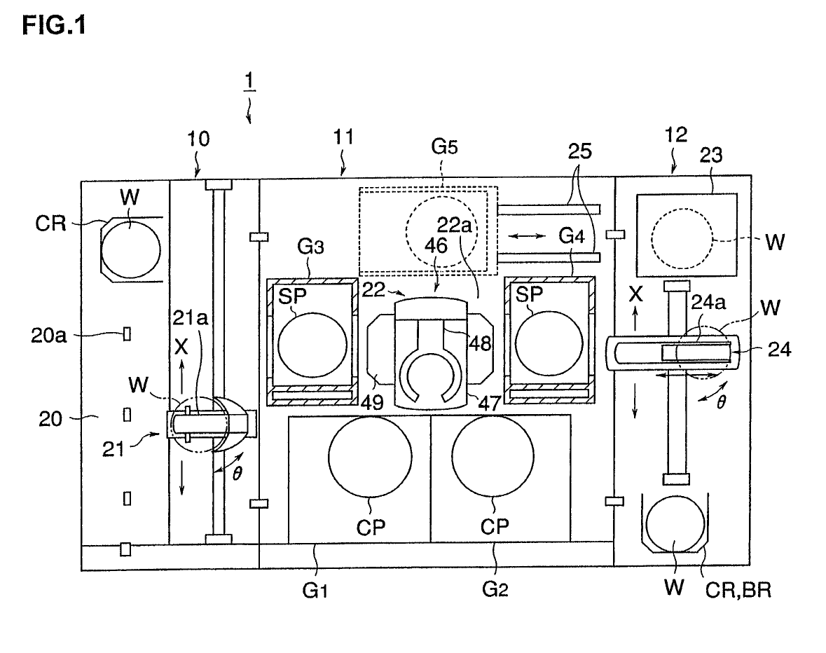

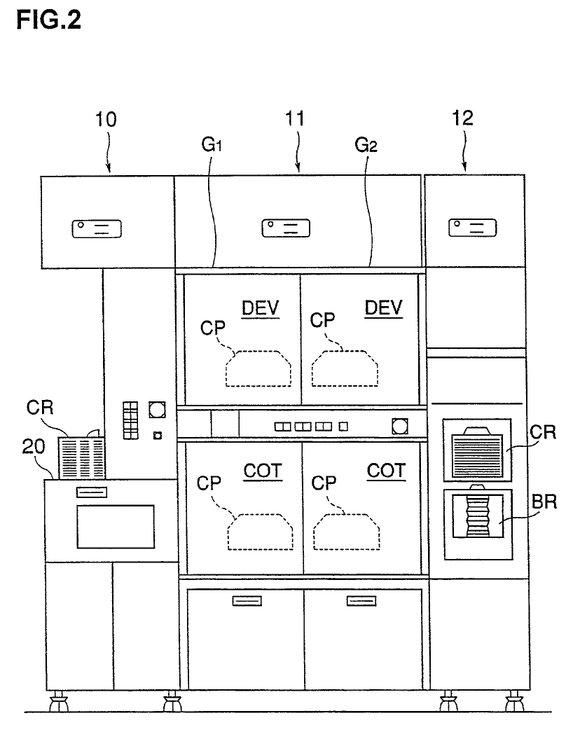

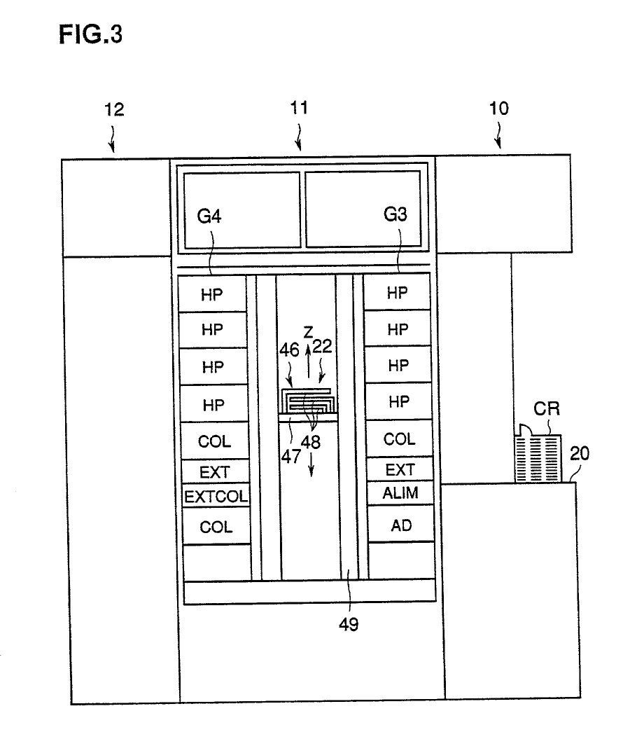

FIG. 1 is a plane view showing an outline of the entire structure of the resist coating and developing treatment system which includes the adhesion unit according to the embodiment of the present invention, FIG. 2 is a front view thereof, and FIG. 3 is a rear view thereof.

This treatment system includes a cassette station 10 as a transfer station, a process station 11 including a plurality of process units, and an interface section 12 for delivering an wafer W between the process station 11 and an exposure unit (not shown) which is provided next thereto.

The above cassette station 10 carries a plurality of semiconductor wafers (hereinafter simply referred to as wafer) W as objects to be processed which are, for example, received in a wafer cassette CR in a unit of 25 from the other system into this system or from this system into the other system, and transfers the wafer W between the wafer cassette CR and the process station 11.

In the cassette station 10, as shown in FIG. 1, a plurality of (four in the drawing) positioning projections 20a are formed along an X-direction in the drawing on a cassette mounting table 20, and at positions of these projections 20a, the wafer cassettes CR can be mounted in a line with respective wafer access ports facing toward the process station 11 side. In the wafer cassette CR, the wafers W are arranged in a vertical direction (Z-direction). Moreover, the cassette station 10 includes an wafer transfer mechanism 21 which is placed between the wafer cassette mounting table 20 and the process station 11. The wafer transfer mechanism 21 includes an wafer transfer arm 21a which is movable in a cassette alignment direction (X-direction) and an wafer alignment direction (Z-direction) therein, and the transfer arm 21a makes it possible to selectively get access to any of the wafer cassettes CR. Further, the wafer transfer arm 21a is structured to be rotatable in a θ-direction, thereby allowing to get access to an alignment unit (ALIM) and an extension unit (EXT) which belong to a later-described third process section G₃ of the process station 11 side.

The aforesaid process station 11 includes a plurality of process units for operating a series of process in coating and developing the wafer W, which are disposed at predetermined positions in multiple tiers, whereby the wafer W is processed one by one. As shown in FIG. 1, the process station 11 includes a transfer path 22a in its center part, in which a main wafer transfer mechanism 22 is provided, and all of the process units are disposed around the wafer transfer path 22a. The plurality of process units are divided into a plurality of process sections, and a plurality of process units are disposed in multiple tiers along the vertical direction in the respective process sections.

The main wafer transfer mechanism 22 is, as shown in FIG. 3, equipped with a wafer transfer device 46 which is ascendable and descendable in an up-and-down direction (Z-direction) inside a cylindrical supporting body 49. The cylindrical supporting body 49 is allowed to be rotatable by a rotating drive power of a motor (not shown), and accordingly, the wafer transfer device 46 is also rotatable integrally.

The wafer transfer device 46 includes a plurality of holding members 48 which are movable in a back-and-forth direction of a transfer base 47, and the delivery of the wafer W among the respective process units is realized by these holding members 48.

As shown in FIG. 1, in this embodiment, four process sections G₁, G₂, G₃ and G₄ are actually disposed in the periphery around the wafer transfer path 22a, and a process section G₅ can be disposed as necessary.

Among these, the first and the second process sections G₁, G₂ are disposed side by side on the front side of the system (in a frontward in FIG. 1), the third process section G₃ is disposed next to the cassette station 10, and the fourth process section G₄ is disposed next to the interface section 12. Further, the fifth process section G₅ can be disposed on the rear side.

In the first process section G₁, a resist coating unit (COT) for coating a resist onto the wafer W and a developing unit (DEV) for developing a pattern of the resist are two-tiered from the bottom in order. Similarly, in the second process section G₂, a resist coating unit (COT) and a developing unit (DEV) as two spinner-type process units are two-tiered from the bottom in order.

In the third process section G₃, as shown in FIG. 3, oven-type process units for mounting the wafer W on a mounting table SP to operate a predetermined process are multi-tiered. That is, an adhesion unit (AD) according to the embodiment of the present invention, which operates so-called hydrophobic treatment in order to enhance an adhering property of the resist, the alignment unit (ALIM) for performing alignment, the extension unit (EXT) for carrying in/out the wafer W, a cooling unit (COL) for operating cooling processing, and four hot plate units (HP) which operate heating processing onto the wafer W before/after exposure processing and after developing treatment are eight-tiered from the bottom in order. Incidentally, a cooling unit (COL) which has an alignment function may be provided instead of the alignment unit (ALIM).

Also in the fourth process section G₄, oven-type process units are multi-tiered. Namely, a cooling unit (COL), an extension/cooling unit (EXTCOL) as a wafer transfer section, which includes a cooling plate, an extension unit (EXT), a cooling unit (COL), and four hot plate units (HP) are eight-tiered from the bottom in order.

When the fifth process section G₅ is provided on the rear side of the main wafer transfer mechanism 22, it is set to be movable along a guide rail 25 toward the side as seen from the main wafer transfer mechanism 22. Thus, even when the fifth process section G₅ is provided, space is secured by sliding it along the guide rail 25, so that the maintenance of the main wafer transfer mechanism 22 can be performed easily from its back.

The length of the aforesaid interface section 12 is the same with that of the process station 11 with regard to a depth direction (X-direction). As shown in FIG. 1 and FIG. 2, a transportable pickup cassette CR and a buffer cassette BR of a stationary type are disposed in two tiers in a front part of the interface section 12, a peripheral exposure unit 23 is arranged in its rear part, and an wafer transfer mechanism 24 is arranged in its center part. The wafer transfer mechanism 24 includes an wafer transfer arm 24a, which is movable in the X-direction and the Y-direction to be accessible to both cassettes CR, BR and the peripheral exposure unit 23. Further, the wafer transfer arm 24a is rotatable in the θ-direction, thereby allowing to get access to the extension unit (EXT) which belongs to the fourth process section G₄ of the process station 11, and further, to an wafer delivery table (not-shown) of the exposure unit side, which is adjacent thereto.

In the resist coating and developing treatment system like this, first in the cassette station 10, the wafer transfer arm 21a of the wafer transfer mechanism 21 gets access to the wafer cassette CR housing the wafers W which are not processed on the cassette mounting table 20, removes one wafer W from the cassette CR, and transfers it to the extension unit (EXT) of the third process section G₃.

The wafer W is carried from the extension unit (EXT) into the process station 11 by the wafer transfer device 46 of the main wafer transfer mechanism 22. Then, after undergoing alignment in the alignment unit (ALIM) of the third process section G₃, it is transferred to the adhesion unit (AD) to be subjected to hydrophobic treatment (HMDS treatment) in order to enhance the adhering property of the resist. Since this treatment requires the heating, the wafer W is transferred to the cooling unit (COL) thereafter by the wafer transfer device 46 to be cooled.

The wafer W after the adhesion treatment and the cooling in the cooling unit (COL) is continuously transferred to the resist coating unit (COT) by the wafer transfer device 46, in which a resist coating film is formed thereon. After the coating treatment, the wafer W undergoes a prebaking processing in either of the hot plate units (HP) of the process sections G₃, G₄, and thereafter, it is cooled in either of the cooling units (COL).

After the cooling, the wafer W is transferred to the alignment unit (ALIM) of the third process section G₃ to be subjected to alignment, and subsequently, transferred to the interface section 12 through the extension unit (EXT) of the fourth process section G₄.

In the interface section 12, a peripheral exposure is performed to the periphery of the wafer W, for example, to a peripheral portion of 1.5 mm thereof in order to remove the extra resist, and thereafter, exposure processing is performed onto the resist film of the wafer W according to a predetermined pattern in the exposure unit (not shown) which is provided next to the interface section 12.

After the exposure, the wafer W is returned to the interface section 12 again, and transferred to the extension unit (EXT) which belong to the fourth process section G₄ by the wafer transfer mechanism 24. Then, the wafer W is transferred to either of the hot plate units (HP) by the wafer transfer device 46 to be subjected to a post-exposure baking processing, and thereafter, cooled in the cooling unit (COL).

Subsequently, the wafer W is transferred to the developing unit (DEV), in which the exposure pattern is developed and the peripheral resist is removed. After the developing, the wafer W is transferred to either of the hot plate units (HP) to be subjected to a post-baking processing, and thereafter, cooled in the cooling unit (COL). When a series of the processes as described above completes, the wafer W is returned to the cassette station 10 through the extension unit (EXT) of the third process section G₃, and received in either of the wafer cassettes CR.

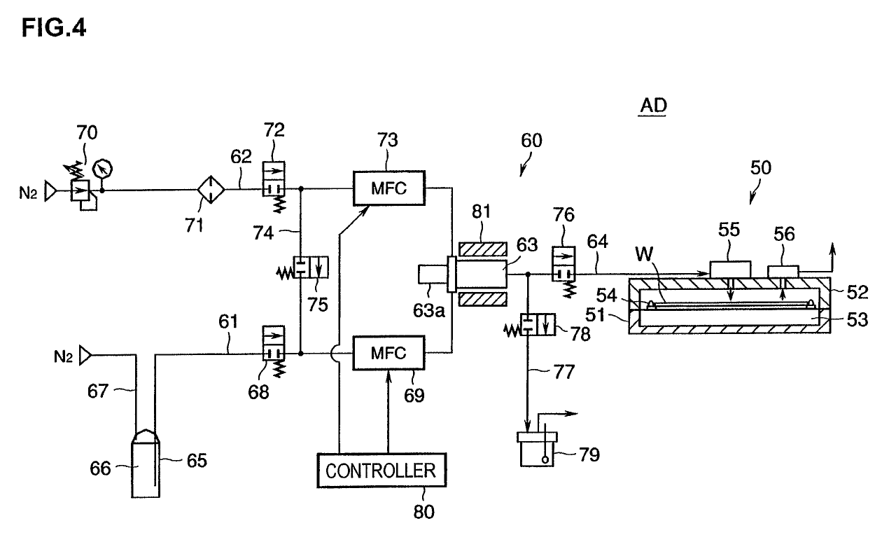

Next, the adhesion unit (AD) according to the embodiment of the present invention will be explained with reference to FIG. 4.

The adhesion unit (AD) includes a chamber 50 for receiving the wafer W and a HMDS gas supply section 60.

The chamber 50 includes a lower member 51 which receives a heating plate 53 for supporting the wafer W and heating the wafer and a cover member 52 which is removably provided to the lower member 51. On a surface of the heating plate 53, for example, six positioning pins 54 (only two of these are shown in the drawing) are provided. A lower part of the positioning pin 54 is a spacer (in a thickness of, for example, 0.1 mm), and the wafer W is aligned by the positioning pin 54 and disposed at a position spaced from the heating plate 53 by the spacer to be heated with a so-called proximity system. On an upper surface of the cover member 52, a gas lead-in port 55 and a gas exhaust port 56 are provided, and an HMDS gas and a purge gas are led into the chamber 50 from the gas lead-in port 55, and the gas inside the chamber 50 is exhausted from the gas exhaust port 56.

The HMDS gas supply section 60 includes a liquid HMDS supply line 61 for supplying HMDS in a liquid state, a carrier gas line 62 for supplying, for example, an N₂ gas as a carrier gas, a vaporizer 63 for vaporizing HMDS in the liquid state, and a gasified HMDS supply line 64 for supplying HMDS in a gaseous state which is vaporized in the vaporizer 63 by being carried by N₂ as the carrier gas to the chamber 50. Incidentally, an actuator 63a as a vaporization concentration control valve is provided in the vaporizer 63. Further, near the vaporizer 63, a heater 81 which has a temperature controlling function is provided as a temperature control means for vaporization stability and vaporization acceleration. The vaporizer 63 in this embodiment has a structure like an atomizer.

The liquid HMDS supply line 61 is inserted into an HMDS tank 65 in which liquid HMDS 66 is stored, and the N₂ gas is supplied into the HMDS tank 65 through the N₂ gas line 67, thereby force-feeding liquid HMDS 66 inside the tank 65 through the liquid HMDS supply line 61. An opening/closing valve 68 and a mass flow controller 69 as a flow control device are placed from an upstream side on the liquid HMDS supply line 61 in between.

The carrier gas line 62 is the line for supplying, for example, the N₂ gas as the carrier gas from a not-shown gas supply source to the vaporizer 63, and a regulator 70, a filter 71, an opening/closing valve 72 and a mass flow controller 73 as a flow control device are placed from an upstream side in between.

A part between the opening/closing valve 68 and the mass flow controller 69 of the liquid HMDS supply line 61 and a part between the opening/closing valve 72 and the mass flow controller 73 of the carrier gas line 62 are connected by a by-pass line 74, and an opening/closing valve 75 is provided on the by-pass line 74. The by-pass line 74 is used in purging the liquid line piping by the N₂ gas when the maintenance is performed.

On the gasified HMDS supply line 64, an opening/closing valve 76 is placed in between, and a drain line 77 is connected thereto at a position right under the vaporizer. An opening/closing valve 78 is provided on the drain line 77 and a drain tank 79 is connected thereto.

A controller 80 controls the mass flow controller 69 of the liquid HMDS supply line 61 and the mass flow controller 73 of the carrier gas line 62, and besides, it can control the opening/closing valves provided to the respective lines although controlling lines are not illustrated. The controller 80 is controlled by a unit controller (not shown) of the adhesion unit (AD).

In thus structured adhesion unit (AD), the wafer is first set on the heating plate 53 inside the chamber 50, the cover member 52 is attached onto the lower member 51 to obtain a half sealed state, and HMDS in a gaseous state is supplied into the chamber 50 from the HMDS gas supply section 60. While supplying the HMDS gas, the gas inside the chamber is exhausted through the gas exhaust port 56.

On this occasion, HMDS in the gaseous state is formed in the vaporizer 63 by supplying liquid HMDS 66 inside the HMDS tank 65 to the vaporizer 63 through the liquid HMDS supply line 61 by force-feeding the N₂ gas in the HMDS gas supply section 60. Further, HMDS in the gaseous state which is formed in the vaporizer 63 is led through the gasified HMDS supply line 64 into the chamber 50 from the gas lead-in port 55 by being carried by the carrier gas (N₂ gas) which is supplied into the vaporizer 63 through the carrier gas line 62. After the adhesion treatment by HMDS, the supplying of HMDS is stopped and the purge gas is flowed into the chamber.

Thus, in this embodiment, liquid HMDS 66 is vaporized by the vaporizer 63 while controlling the amount of a liquid flow of the liquid HMDS supply line 61, which makes it possible to perform vaporization in a certain amount from a certain amount of the liquid and to surely and controllably form an HMDS gas atmosphere with stable concentration, without being influenced by environment as in the conventional natural vaporization. Further, the mass flow controller 69 is provided on the liquid HMDS supply line 61 so that the amount of supplying liquid HMDS can be controlled, and the mass flow controller 73 is provided on the carrier gas supply line 62 so that the amount of vaporizing liquid HMDS and the supplying amount of vaporized HMDS can be easily controlled, thereby allowing the concentration of the atmosphere to be controlled quite easily. When HMDS in the gaseous state which is vaporized naturally in the tank is supplied as is conventional, which is bad for stability of the concentration and for controllability, there arises a problem of a so-called “dead liquid” which remains in the lower part of the tank over a long period of time without being vaporized, but this kind of problem can be eliminated when the vaporizer 63 is used as in this embodiment.

Moreover, in supplying HMDS like this, it is preferable that the controller 80 controls the mass flow controller 69 of the liquid HMDS supply line 61 to be opened after the carrier gas is flowed in the carrier gas supply line 62 by opening the mass flow controller 73 of the carrier gas line 62 when the supplying is started, and the mass flow controller 73 of the carrier gas supply line 62 to be closed after the supplying of liquid HMDS is stopped by closing the mass flow controller 69 of the liquid HMDS supply line 61 when the supplying of gas is finished. By controlling like this, the supplying of liquid HMDS only to the vaporizer 63 can be inhibited and the flowing-in of HMDS in a liquid state without being vaporized to a rear stage of the vaporizer 63 can be prevented.

Further, the drain line 77 is connected to the gasified HMDS supply line 64 so that a drain which exists in the gasified HMDS supply line 64 can be led into the drain tank 79, thereby securely preventing the drain to be supplied into the chamber 50.

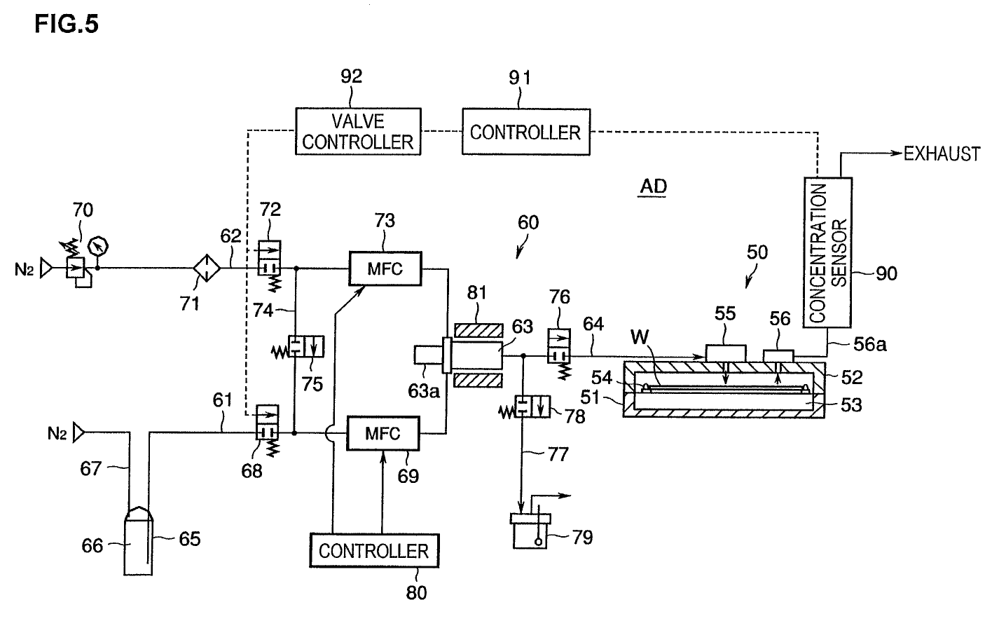

Another embodiment of the present invention will be explained. In an adhesion unit (AD) shown in FIG. 5, a concentration sensor 90 for measuring the concentration of HMDS in an exhaust gas is attached to an exhaust line 56a which is connected to an exhaust port 56.

A measurement result of the concentration sensor 90 is sent to a controller 91 all the time, and the controller 91 compares it with values of a proper range and if it falls outside the aforesaid proper range, it is outputted to a valve controller 92.

When receiving a signal that the concentration falls outside the proper range from the controller 92, the valve controller 92 controls the opening/closing valves to close the opening/closing valve 72 of the carrier gas line 62 and the opening/closing valve 68 of the liquid HMDS line 61. In this case, it is preferable to report to the outside that it falls outside the proper range of the concentration which is previously set.

Therefore, during the adhesion treatment of the wafer W, even when the concentration of HMDS in the chamber falls outside a predetermined range for some reason, the treatment can be immediately interrupted at that point of time. As this result, manufacturing of defective products can be previously prevented.

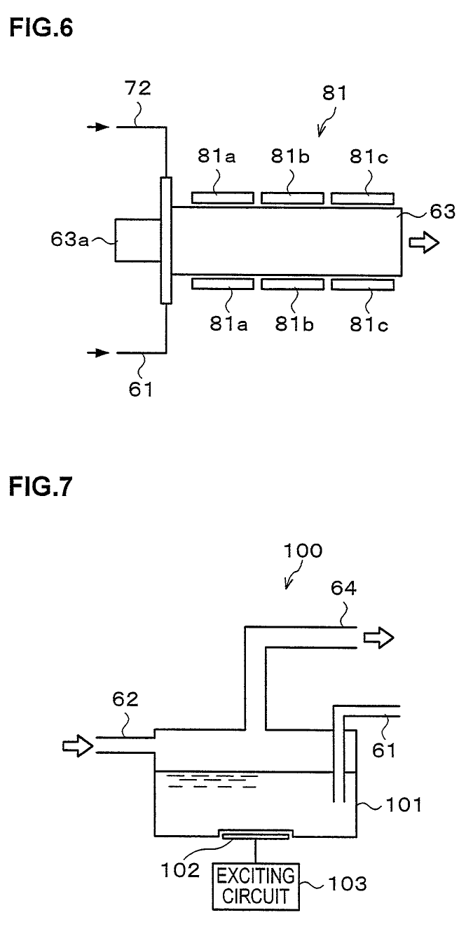

The aforesaid heater 81 which is provided near the vaporizer 63, for example as shown in FIG. 6, may includes divided heater modules 81a, 81b, 81c in a longitudinal direction of the vaporizer 63 (namely, in a direction along a blowing-out direction of the gas after vaporization).

In the vaporizer 63, a temperature of the gas near an outlet port of the vaporizer 63 is lower than a temperature of the gas immediately after evaporation. This is due to the latent heat by vaporization of the liquid.

Therefore, temperatures of the heater modules are set to be higher so that the heating temperatures become higher in the order of the heater modules 81a, 81b and 81c, whereby the temperature can be regulated by heating the vaporizer 63 corresponding to a temperature gradient of the vaporizer 63. As a result, the temperature of the vaporized gas which is supplied into the chamber 50 can be controlled more precisely.

It should be mentioned that, when changing the concentration of HMDS in the gas being supplied to the chamber 50, for example, between the respective lots of the wafer W, it is preferable that the carrier gas is first flowed into the vaporizer 63 for purging, before the change. In this case, the heating temperature by the heater 81 is set to be higher than the temperature during the treatment, which makes it possible to purge HMDS which remains in the vaporizer 63 by vaporizing it more quickly.

In the changing of the concentration like this, before the treatment of the wafer W, the vaporizer 63 is temporarily activated in a normal mode (an operation mode similar to the actual treatment of the wafer W) before carrying in the wafer W into the chamber 50 to perform a so-called dummy treatment in order to verify operations of the gas supplying system, for example, the gasified HMDS supply line 64 between the respective lots.

The aforesaid vaporizer 63 is the vaporizer of a two-fluid atomizing type which blows out the liquid and the compressed carrier gas simultaneously, but a vaporizer 100 of an ultrasonic type can be used as shown in FIG. 7.

The vaporizer 100 includes a vaporizing chamber 101 and an oscillator 102 which is attached to a bottom part of the vaporizing chamber 101. The carrier gas line 62 and the liquid supply line 61 are connected to the vaporizing chamber 101. When ultrasonic waves are given to the oscillator 102 from an exciting circuit 103, HMDS stored in the vaporizing chamber 100 is atomized by the oscillator 102. Thus structured vaporizer 100 can be used in the present invention.

It should be noted that the present invention is not limited to the above embodiment, and various changes can be made. In the above embodiment, the example in which the present invention is applied to the adhesion unit of the resist coating and developing treatment system is shown, but it is not restrictive and it can be applied to cases in which a gasified atmosphere is formed by vaporizing liquid materials. For example, in SOD (Spin On Dielectric) treatment device which forms a dielectric film onto a wafer by coating a solution, a process exists in which the wafer is exposed to the atmosphere of the HMDS gas, an ammonia gas and the like, and the present invention can be applied to the process like this. Further, in a dry developing device in which a resist pattern is developed by a gas without using a developing solution, the present invention can be applied when the wafer is exposed to a developing gas atmosphere. Further, in the above embodiment, the mass flow controller is used for controlling the flow, which is not necessarily limited to the mass flow controller. Furthermore, the supplying of the liquid is performed by the gas force-feeding, which is not restrictive and a pump or the like may be used. Moreover, in the above embodiment, the case in which the semiconductor wafer is used as a substrate is explained, but it is also applicable to the substrates to be processed other than the semiconductor wafer, such as an LCD substrate.

As described above, according to the present invention, the liquid is vaporized by the vaporizer while controlling the amount of the liquid flow of the liquid line, which makes it possible to perform vaporization in a certain amount from a certain amount of the liquid and to surely and controllably form the gaseous atmosphere with stable concentration, without being influenced by environment. Particularly, the mass flow controller is provided on the liquid line and the carrier gas line so that the amount of vaporizing liquid and the supplying amount of vaporized liquid can be easily controlled, thereby allowing the concentration of the atmosphere to be controlled quite easily.

Moreover, a controlling device is provided to control the liquid line to be opened after the carrier gas line is opened when the supplying of the gas is started, and the carrier gas line to be closed after the liquid line is closed when the supplying of the gas is finished, whereby the supplying of the liquid only to the vaporizer can be inhibited and the flowing-in of the liquid as it is without being vaporized to the piping after the vaporizer can be prevented.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A treatment apparatus for performing a predetermined treatment by exposing a substrate to a gaseous atmosphere, comprising:
a chamber for receiving the substrate;
a liquid line for supplying a liquid for forming the gaseous atmosphere;
a liquid flow control device for controlling an amount of a liquid flow of the liquid line;
a vaporizer for vaporizing the liquid supplied from the liquid line;
a carrier gas line for supplying a carrier gas for carrying a gas vaporized in the vaporizer; and
a gas supply line for supplying the gas vaporized in the vaporizer into the chamber while being carried by the carrier gas.

2. A treatment apparatus as set forth in claim 1, further comprising:
a carrier gas flow control device provided on said carrier gas line for controlling a flow amount of the carrier gas.

3. A treatment apparatus as set forth in claim 1, further comprising:
a control device for controlling said liquid line to be opened after said carrier gas line is opened when a supplying of the gas is started, and the carrier gas line to be closed after the liquid line is closed when the supplying of the gas is finished.

4. A treatment apparatus as set forth in claim 1,
wherein said liquid line supplies the liquid by a gas force-feeding.

5. A treatment apparatus as set forth in claim 1, further comprising:
a drain line provided on said gas supply line for collecting a drain.

6. A treatment apparatus as set forth in claim 1,
wherein said vaporizer is a vaporizer having a system of vaporizing the liquid by ultrasonic vibration.

7. A treatment apparatus as set forth in claim 1, further comprising:
a concentration sensor for detecting a concentration of a liquid component in an exhaust gas from said chamber; and
a control device for closing said liquid line and said carrier gas line when a detected result by the concentration sensor falls outside a predetermined threshold.

8. A treatment apparatus as set forth in claim 1, further comprising:
a heater for regulating a temperature of said vaporizer.

9. A treatment apparatus as set forth in claim 8,
wherein a heating temperature of the heater to said vaporizer is set to become higher toward a downstream side of the vaporizer.

10. A treatment apparatus as set forth in claim 8,
wherein the heater heats said vaporizer at a higher temperature than a heating temperature during the predetermined treatment when purging an inside of the vaporizer.

11. A treatment apparatus for performing a predetermined process by exposing a substrate to a gaseous atmosphere, comprising:
a chamber for receiving the substrate;
a liquid line for supplying a liquid for forming the gaseous atmosphere;
a first flow control device provided on the liquid line;
a vaporizer for vaporizing the liquid supplied from the liquid line;
a carrier gas line for supplying a carrier gas for carrying a gas vaporized in the vaporizer;
a second flow control device provided on the carrier gas line; and
a gas supply line for supplying the gas vaporized in the vaporizer into the chamber while being carried by the carrier gas.

12. A treatment apparatus as set forth in claim 11,
wherein each of said first and second flow control devices comprises a mass flow controller.

13. A treatment apparatus as set forth in claim 11, further comprising:
a control device for controlling the mass flow controller of said first flow control device of said liquid line to be opened after the mass flow controller of said second flow control device of said carrier gas line is opened when a supplying of the gas is started, and the mass flow controller of the second flow control device to be closed after the mass flow controller of the first flow control device is closed when the supplying of the gas is finished.

14. A treatment apparatus as set forth in claim 11,
wherein said liquid line supplies the liquid by a gas force-feeding.

15. A treatment apparatus as set forth in claim 11, further comprising:
a drain line provided on said gas supply line for collecting a drain.

16. A treatment apparatus as set forth in claim 11,
wherein said vaporizer is a vaporizer having a system of vaporizing the liquid by ultrasonic vibration.

17. A treatment apparatus as set forth in claim 11, further comprising:
a concentration sensor for detecting a concentration of a liquid component in an exhaust gas from said chamber; and
a control device for closing said liquid line and said carrier gas line when a detected result by the concentration sensor falls outside a predetermined threshold.

18. A treatment apparatus as set forth in claim 11, further comprising:
a heater for regulating a temperature of said vaporizer.

19. A treatment apparatus as set forth in claim 18,
wherein a heating temperature of the heater to said vaporizer is set to become higher toward a downstream side of the vaporizer.

20. A treatment apparatus as set forth in claim 18,
wherein the heater heats said vaporizer at a higher temperature than a heating temperature during the predetermined treatment when purging an inside of the vaporizer.
